(19) United States
(12) Patent Application Publication
(10) Pub. No.: US 2002/0052811 A1
(43) Pub. Date: May 2, 2002

(54) Service independent e-commerce marketing system

(76) Inventor: Thorsten Hoins, Pasadena, CA (US)

Correspondence Address: M. John Carson, Esq., Fulbright and Jaworski L.L.P., 865 South Figueroa Street, Suite 2900, Los Angeles, CA, 90017, US

(21) Appl. No.: 09/777,258

(22) Filed: Feb. 5, 2001

Related U.S. Application Data
(60) Provisional application No. 60/244,866, filed on Nov. 1, 2000.

(51) Int. Cl. G06F 17/60

(52) U.S. Cl. 705/34

(57) ABSTRACT

A novel method of offering services to customers by creating a marketing program which allows members in the program to contribute a first percentage of each member's monthly payment to a charitable organization designated by the member. In addition, the member also receives credits equal to a second percentage of any bill payments of other members referred by this member to join this program.

### BACKGROUND OF THE INVENTION

The present invention relates to a method of marketing and selling utility services. More particularly, the present invention provides a method of efficiently merchandising a number of services such as residential telecommunications, utilities, and related services. The present invention operates irrespective of the current market presence, financial might, or brand strength of the corresponding industries leading players.

Promotional expenditures in the U.S. residential telecommunications and utility markets continue to balloon. According to one research, well over thirty percent of projected revenues of some utility companies are allocated for sales and marketing, and the trend keeps spiraling upward. For example, one major long distance company suggests that almost half of charges to the consumers for long distance service is allocated for sales and marketing. Additionally, good customers are generally carrying the burden of all these promotional expenditures. Only when customers decide to nag or switch their providers do they share in the rewards for which the remaining loyal or content customers continually pay. In other words, good customers are punished for loyalty.

Progressive deregulation in virtually all telecommunication and utility sectors was supposed to bring about competition from nimble new players. Whether competing on lower prices or better services, these new entrants, it was believed, would, through sheer innovation, be able to compete with the established entities, and, in turn, deliver better services at lower prices to consumers. The reality of deregulation however is producing unprecedented waves of consolidation, evidenced by mergers and acquisitions rapidly increasing in number and size. For example, one long distance company has acquired over fifty potential competitors in just fifteen years between 1984 and 1999.

The core reason for the situation described above is not supply and demand based. Instead, it is an inability of new providers to compete effectively against the well-funded marketing might of incumbent providers. As one consultant describes the situation in telecom, “Bizarrely, it's not a network game. It's a marketing game.”

Hence, deregulation and competition thus far have failed to fully realize their intended benefits for emerging providers and consumers alike. Through a novel e-commerce system of offering services to customers, and a novel e-commerce system of distribution of marketing funds, we believe to be able to remedy some of the above challenges.

Further, virtually all companies today are custodians of a specific product or service that they are looking to market. The present invention renders that strategy duplicative and expensive. Instead, the present invention aims to be the custodian of a pool of customers that respond favorably to our acquisition, retention and service method described herein. It allows for the sale of a plurality of different services to the same customer pool.

The present invention solves another set of challenges. Non-profits are zealously soliciting funds to support their worthy projects. Yet, rising costs and relative unpredictability of fundraising efforts continue to put a strain on most every non-profit organization. Thus, the “holy grail” of the non-profit sector is increasing predictable, sustainable income combined with decreasing marketing and administrative expenditures.

The present invention provides an efficient method of promoting the utility services, while being able to contribute to charitable organizations. It operates irrespective of the current market presence, financial might, or brand strength of the corresponding industries' leading players.

Additional objectives, features and advantages of various aspects of the present invention will become apparent from the following description of its preferred embodiments, which description should be taken in conjunction with the accompanying drawings.

### SUMMARY OF THE INVENTION

It is therefore an objective of the present invention to provide an efficient method of promoting and selling utility services.

It is another objective of the present invention to allow customers to contribute to a designated charitable organization.

It is another objective of the present invention to allow customers to receive credits equal to a percentage of the monthly payments of their referred customers.

The present invention provides a novel method of offering a plurality of services to customers by creating a marketing program which allows members in the program to contribute a first percentage of each member's monthly payment to a non-profit organization designated by the member. In addition, the member also receives credits equal to a second percentage of any bill payments of members referred by this member to join this program.

Additional objectives, features and advantages of various aspects of the present invention will become apparent from the following description of its preferred embodiments, which description should be taken in conjunction with the accompanying drawings.

### BRIEF DESCRIPTION OF THE DRAWINGS

FIG. 1 shows conceptually how the marketing program according to the present invention works with a charitable organization, multiple service providers, and members of the program.

FIG. 2 illustrates how the program provider distributes contributions to the charitable organization and allocate credits to the referring members.

FIG. 3 is a flow chart showing detailed operation of the marketing program according to the present invention.

FIGS. 4A, 4B, 4C provide an example of a member JD who signed up with the program.

FIGS. 5A, 5B show a sample monthly billing statement and a sample year-end statement for the example as shown in FIGS. 4A, 4B, 4C.

### DETAIL DESCRIPTION OF THE DRAWINGS

The present invention provides a novel method of offering a plurality of services such as residential telecommunications, electricity, cable TV services and internet services, etc. to customers. Instead of allocating money to traditional marketing expenditures, the present invention creates a marketing program which allows members of the program to achieve the following:

1. contribute a certain percentage (e.g. a first percentage) of each bill payment of each member to the account of a non-profit organization designated by the member.

2. receive as credits another percentage (e.g. a second percentage) of the bill payment of each member referred by this member to join this program. For example, if a first member refers a second member, a second percentage of the second member's bill payments will be credited to the account of the first member, bill after bill after bill.

All charitable organizations are allowed to participate in the program and soliciting members for the program. After joining the program, the charitable organizations are free to sign up members. After the members have signed up for the program, the program provider will begin to contribute a first percentage (e.g. ten percent) of each monthly payments of the solicited members to the designated charitable organization. Further, if any of these members also solicit additional members to join this program, the program provider will also contribute a first percentage of the monthly payment of additional members solicited by the members to the designated charitable organization. Therefore, the present invention gives every non-profit organization a free tool to build capital campaigns that can generate additional income from the supporter base and beyond. It also gives customers financial incentive to ask others to support their own favorite causes. The present invention will inspire an exponentially perpetuating ‘word of mouth’ cycle of customer attraction and retention while concurrently eliminating the need for most traditional promotional expenditures.

The marketing program is designed to offer this fundraising system to all registered non-profit organizations, which, in turn, have every incentive to promote the program. Currently, no other marketing program has provided every non-profit organization with free assistance to reach their financial goals by offering their supporters perpetual and steep discounts for donor (member) acquisition.

The marketing program according to the present invention can either be web enabled billing or traditional paper billing. In addition, the customer relationship management system of the marketing program according to the present invention allows the program provider to market services, serve charity, and bill and collect on behalf of the respective service providers.

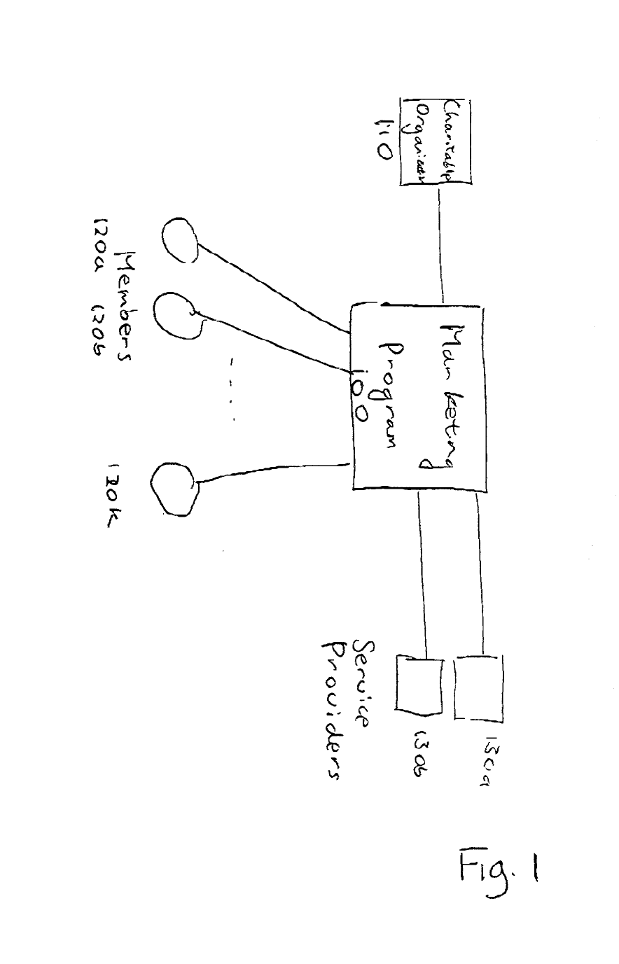

FIG. 1 shows conceptually how the marketing program of the present invention works with a charitable organization, multiple service providers, and members of the program. As shown in the figure, the service program 100 has signed up a charitable organization 110 as the beneficiary for the marketing program. Then the charitable organization 110 solicited and signed up members 120a, 120b . . . 120k to participate in the program. The members of the program are allowed to choose from any of the service providers 130a, 130b. As discussed above, the service providers 130a, 130b can be any utility companies. After the members have designated the service providers, a certain percentage of the monthly payments of each members will be contributed to the charitable organization.

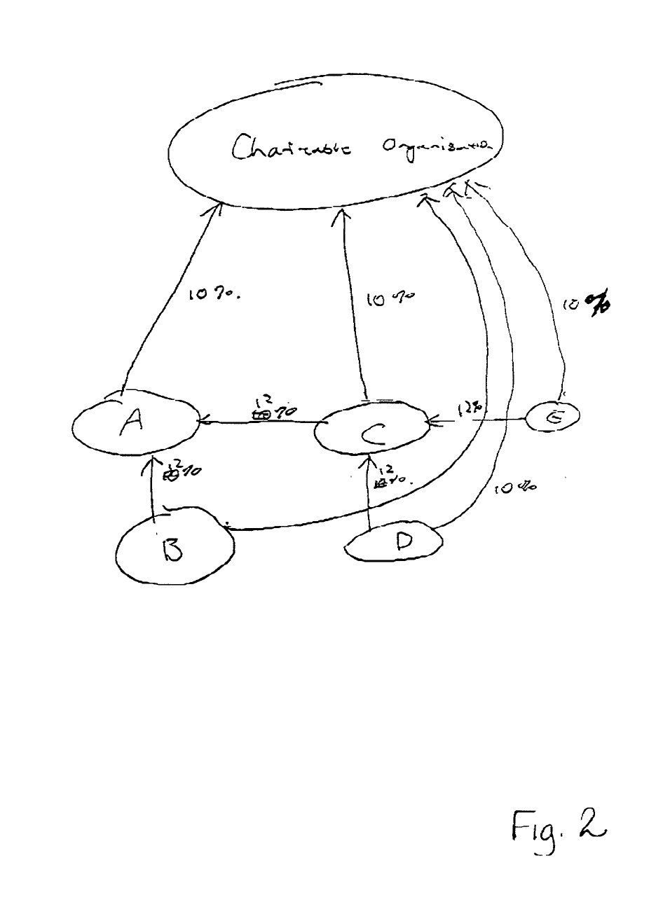

FIG. 2 illustrates how the program provider distributes contributions to the charitable organization and credits to the referring members. The figure shows that the charitable organization (“CO”) has signed up with a marketing program according to the present invention. The charitable organization can be a church organization, a university, or any non-profit group. In the example as shown, A, B, C, D, and E are members who have already signed up with the marketing program. Each of these members has designated CO as the charitable organization for monthly contributions. In order to simplify the figure, each of the members A, B, C, D and E has signed up with the same service provider (for example, a utility company). In the present invention, the service provider can be a utility company, an internet provider, or a long distance telephone service provider. After joining the marketing program, CO signed up its first tier customer A, in this example. According to the present invention, the service provider will contribute monthly to the charitable organization CO a percentage of A's monthly utility payment. Contributing to the charitable organization generates two advantages to A. The first advantage is to allow A to contribute monthly to the charitable organization. The contributions equal to a first percentage, for example ten percent, of A's bill payments for his utility bills. The second advantage is to allow A to annually deduct all or a portion of the contributions to CO because contributions to charitable organization may be allowed under the IRS rule to be tax deductible.

After signing up with the marketing program and designating CO as the charitable organization for monthly contribution, A can promote this charitable organization CO and the marketing program to friends and family. In the example as shown in FIG. 1, B and C have signed up for the program through A and also designated CO as the charitable organization. After B and C have selected a utility company as their service provider, a first percentage of each of their utility payments will be contributed to CO. In addition, because B and C were referred by A to participate the program, a second percentage (for example, ten percent) of each of their monthly utility payments will be credited to A.

For example, if the first month utility payments for A, B, and C are $50, $60, $70 respectively. $5 (i.e. ten percent of A's payment $50) will be contributed to CO the following month. $6 (i.e. ten percent of B's payment $60) will be contributed to CO. $7 (i.e. ten percent of C's payment $70) will be contributed to CO. Because B and C are referred to this program by A, $13.0 ($6=ten percent of B's payment+$7 =ten percent of C's payment) will be credited to A's account to be deducted from A's following month bill.

FIG. 2 also illustrates how C can generate credits applied to his monthly bills while assisting CO in recruiting other members. In the present example, C promoted this program to friends and family, and signed up two additional members D and E. After signing up with this program, the first percentage (i.e. ten percent) of D and E's utility payments will be contributed to CO each month. In addition, the second percentage (i.e. ten percent) of D and E's utility payments will be credited to C's following month bill.

As shown in the figure, every participant under this program is a beneficiary of this marketing program. The program provider is responsible for administering this program by signing up new charitable organizations and performing monthly administrative duties. The program provider charges a third percentage of each monthly bill of each program member. Practically, this program provider may charge up to the remaining percentage of what the service company allocated to its marketing budget. For example, if a long distance telephone service provider earmarks thirty percent of its monthly bill payments received to its marketing and advertising budget, the service provider may allow this program provider to charge up to ten percent of each bill payment for its administrative cost. The ten percent is calculated by subtracting the first percentage (i.e. ten percent) and the second percentage (i.e. ten percent) from its allowable marketing budget (i.e. thirty percent).

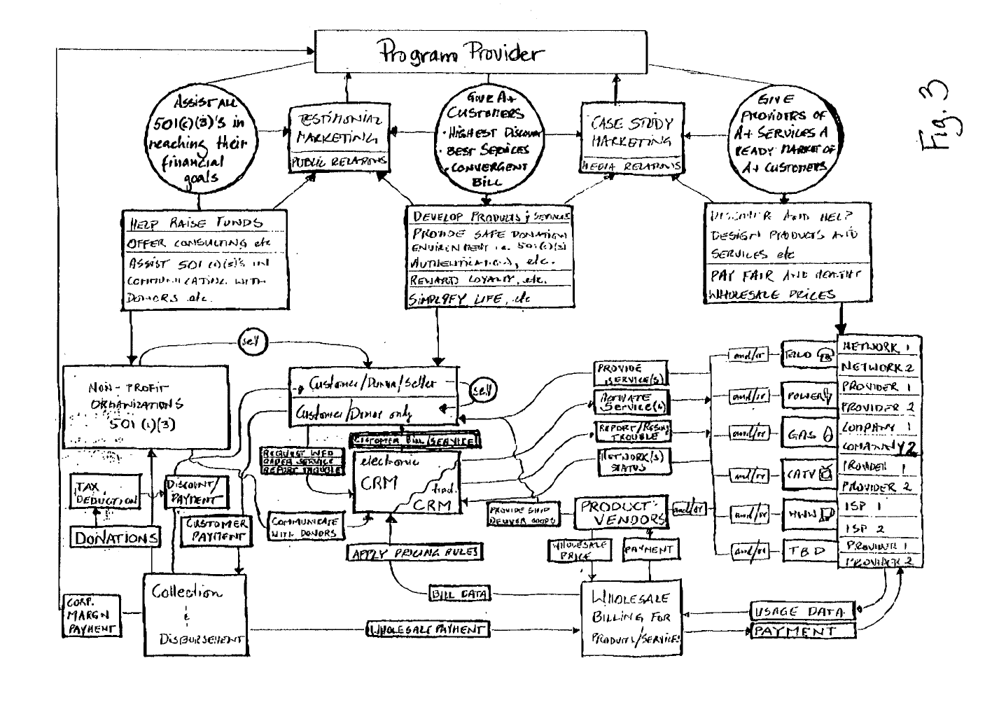

FIG. 3 is a flow chart showing detailed operations of the marketing program according to the present invention. In this preferred example, a plurality of service providers 310a, 310b, 310c, 310d, 310e are participating in this marketing program. The plurality of service providers in this example include a telephone company, a power company, a gas company, a cable television company, an internet provider, etc. In this example as shown, each of these service providers has its own network to provide service to individual customers. In the preferred embodiment according to the present invention, the program provider is an independent company responsible for managing billing and collecting payments for the service providers enrolled in this program.

The program provider has a customer relationship management division (CRM) 320 for managing member relationship by (1) managing each individual member's account; (2) informing the service providers to provide services to the members; (3) informing the service providers to activate services to the members; (4) processing members' requests and reporting any troubles in the service to the service providers; and (5) communicating network status to the members.

At the end of each billing cycle, the program provider handles the billings and collects the payments for the service providers. Each of the billings is calculated according to a pricing rule. The pricing rule determines the distribution of the bill payments received by transferring a first percentage of the payment received to the charitable organization and providing credits to the referrers, and paying the service providers. After the billing is done, the program provider (1) issues billing statements to members; (2) collects payments from its members; (3) transfers contributions to the designated charitable organizations; (4) transfers payments to the service providers; and (5) keeps a portion of the payments as its operating expense and profit.

It should be noted that, by centralizing all the billings, payment collections, and fund disbursements to one program provider, the single program provider is capable of handling multiple service providers.

According to the present invention, the program provider applies the pricing rule in calculating the distributions of the bill payments received to different entities such as the charitable organization, the service providers, and the referrer. The pricing rule for the retail price of the service can be defined as: Retail Price charged to members=Wholesale Price charged by the service providers+a first percentage (i.e. contribution to the charitable organization)+a second percentage (i.e. referral commission)+a third percentage (i.e. payment to the program provider).

The present invention allows each service provider to compete for retail customers using wholesale approaches. In other words, the present invention eliminates both the cost and the headache of the sale and leaves the respective providers with the task of inventing and refining services. The program provider chooses the participating service providers for their ability to deliver a top notch product—not for their marketing savvy/budget/size. This solves a lot of obstacles facing the emerging or second tier service providers. The present invention helps the service providers bringing superior services to market by circumventing the barriers to entry established by well funded market leaders. This also solves the problem of “customers wondering” if the customers are getting the best deal their service providers offer. By giving the exact same deal to every customer, and by making the costs transparent, no customer is better off than any other, except, of course, by virtue of his or her own efforts. This also solves the problem of loyalty punishment. Today, good customers carry the burden of paying marketing expenditures. Only the customers who engage in habitually nagging or switching their providers share the rewards for which the remaining loyal or content customers pay.

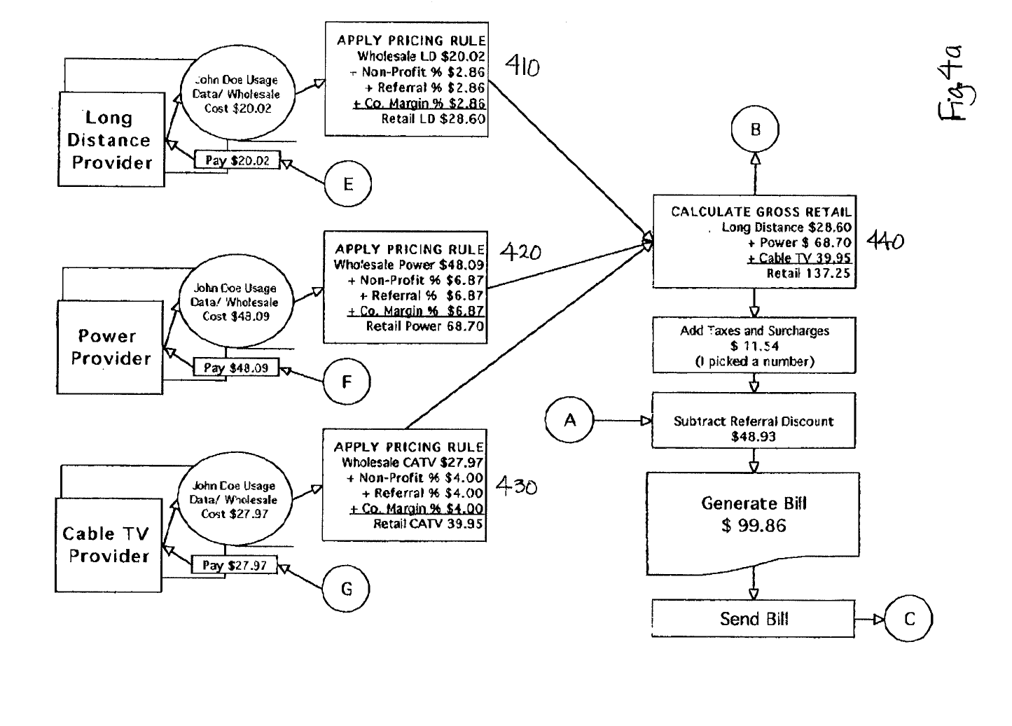

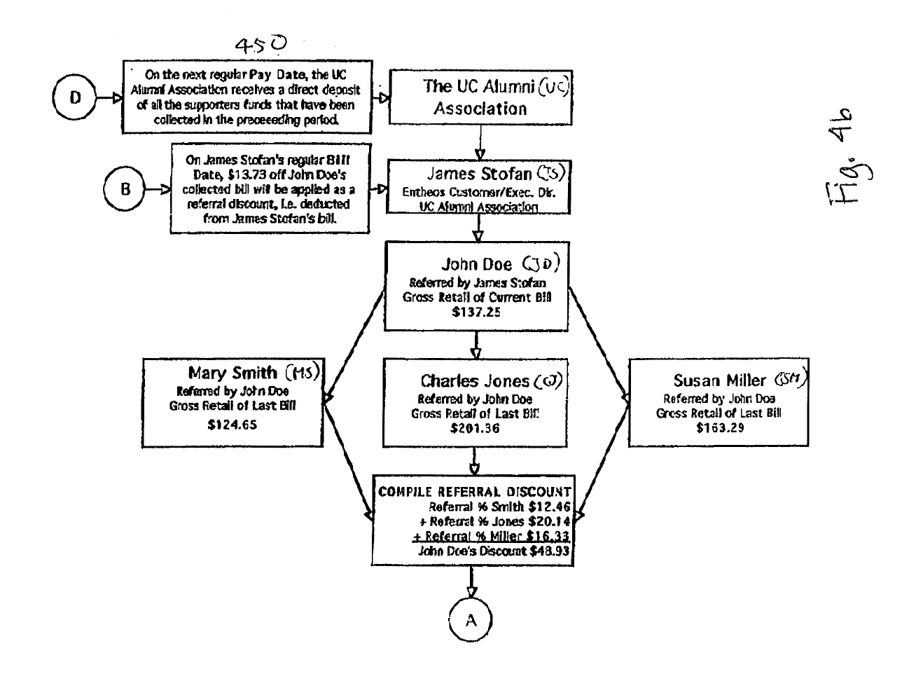

FIGS. 4A, 4B, 4C provide an example of a member JD who signed up with the program. In this example, JD was referred by member JS to join this marketing program. After joining the program, JD referred MS, CJ, and SM to join this program. In this example, the charitable organization which recruited JS is The UC Alumni Association (“UC”).

FIG. 4A shows how the pricing rule is applied to JD's monthly billing statements. In this example, JD is subscribing to three service providers: (1) long distance provider; (2) power provider; and (3) cable TV provider.

As shown in this example, the retail amount charged to JD for the long distance provider on one specific month is $28.60. This amount is calculated by applying the pricing rule as shown in Box 410. In the same month, the retail amount charged to JD for the power provider is $68.70. In addition, the retail amount charged to JD for cable TV service is $39.95.

As shown in Box 440, the gross retail amount for JD in that month is $137.25. The amount stated on the billing statement sent to JD is the gross retail amount adding taxes and surcharges and subtracting the referral credits for his referrals of MS, CJ and SM to the program. These referral credits are explained in detail in the following paragraphs.

Box 450 of FIG. 4B shows that the program provider contributes a first percentage of the monthly payment of JD to UC on the following billing date. In addition, a second percentage of JD's monthly payment is credited to JS for his referral of JD to the program.

Furthermore, because MS, CJ, and SM were all recruited by JD, a second percentage of each of these three members previous month payments is calculated and credited to JD's this month bill. Therefore, $48.93 is credited to JD the following month payment based on the previous month payments of MS ($124.65), CJ ($201.36), and SM ($163.29).

FIG. 4C shows the distributions of JD's current month payment of $99.86 and accumulated credits of $48.93. The total amount of JD's current month payment is then $137.3 (i.e. $99.86+$48.93−$11.54 for taxes and surcharges). In the present example, a third percentage of JD's total amount (i.e. $13.73) goes to the program provider according to the pricing rule. The amounts of $20.02, $48.09, and $27.97 go to the three service providers: long distance service provider, power provider, and cable TV provider. The amount of $13.73 is credited to JS's next month bill. And, finally, a first percentage of this month bill of $13.73 goes to the designated charitable organization, UC.

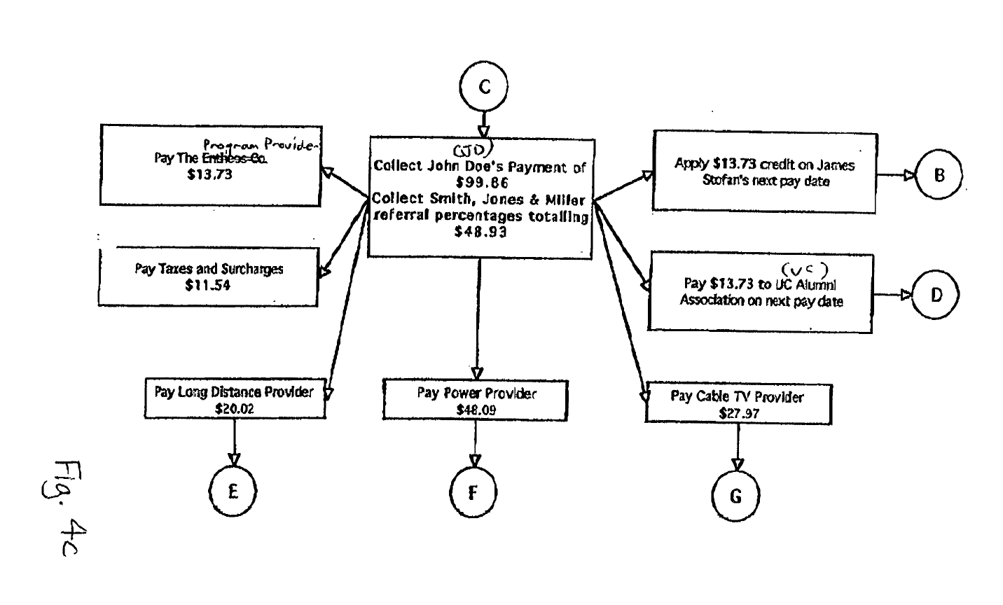

FIGS. 5A, 5B show a sample monthly billing statement and a sample year-end statement for the example as shown in FIGS. 4A, 4B, 4C. According to the present invention, the billing statements can be printed and sent to each customer, or be emailed or posted on-line for each member to pay.

According to the present invention, these billing statements are a powerful tool for any participating charitable organization to contact its members. For example, a charitable organization in the program is allowed to communicate with its supporters on the monthly billing statements. After a charitable organization has signed up with the program, the charitable organization is allowed put a message in a designated message field in the monthly statements of any members designating it as the charitable organization. As shown in the figure, this message 510 can be integrated into the actual billing statements. This provides two major advantages for the charitable organization. First, the communication is directed to its members monthly. This solves the problem of unopened direct mail envelopes to its known supporters. Second, the communication with supporters is not financed with supporters' cash. This solves the substantial cash and image problem many non-profit organizations are facing when they “paper their supporters to death.”

The foregoing description has been limited to a specific embodiment of this invention. It will be apparent, however, that variations and modifications may be made to the invention, with the attainment of some or all of the advantages of the invention. Therefore, it is the object of the appended claims to cover all such variations and modifications as come within the true spirit and scope of the invention.

What is claimed is:

1. A process for handling sales of services under a marketing program by a service company, comprising:
(1) signing up a charitable organization for said marketing program;
(2) recruiting a member for said marketing program, wherein said member desginates said charitable organization as a beneficiary for said program;
(3) offering said member services a plurality of service providers;
(4) allowing said member to select at least one service from said plurality of services;
(5) processing billings for the service selected by said member;
(6) collecting payments from said member based on said billings;
(7) contributing a first percentage of said payments to said charitable organization; and
(8) crediting a second percentage of said payments to a referrer if said member is referred to sign up for said marketing program, and
wherein steps (1) and (3)-(8) are performed by said service company.

2. The method for handling sales according to claim 1, wherein said bill processing step includes sending monthly billing statements to said user.

3. The method for handling sales according to claim 1, wherein said independent company applies pricing rules in determining said first percentage and said second percentage.

4. The method for handling sales according to claim 1, wherein said plurality of service providers include a long distance telephone service provider.

5. The method for handling sales according to claim 1, wherein said plurality of service providers include a utility provider.

6. The method for handling sales according to claim 1, wherein said plurality of service providers include a cable television provider.

7. The method for handling sales according to claim 1 further comprising the step of communicating with said user using a billing statement.

8. The method for handling sales according to claim 1, further comprising distributing a third percentage of said payments to a referrer if said member is signed up for said marketing program by said referrer.

9. A method for handling sales of services under a marketing program by a program provider, comprising:
(1) signing up a user for said marketing program;
(2) allowing said user to select a charitable organization for contribution;
(3) providing said user a plurality of service providers to choose from;
(4) selecting at least one service from said plurality of service providers;
(5) processing billing for the selected service, wherein said billing is processed by said program provider based on a pricing rule, said pricing rule computes a retail price by adding a wholesale price, a charitable contribution, a referral commission and a service charge;
(5) sending a billing statement to said user, wherein said charitable organization communicates with said user through said billing statement;
(6) collecting payment by said program provider based on said billing statement;
(7) distributing said charitable contribution to said charitable organization, wherein said charitable contribution equals a first percentage of said payment; and
(8) distributing said referral commission to a referrer, wherein said user was signed up by said referrer, said referral commission equaling a second percentage of said payment; and
(10) said program provider keeping said service charge.
